(19) United States
(12) Patent Application Publication
(10) Pub. No.: US 2008/0162445 A1
(43) Pub. Date: Jul. 3, 2008

(54) DETERMINING SATISFIABILITY AND TRANSITIVE CLOSURE OF A WHERE CLAUSE

(76) Inventor: Ahmad Ghazal, Redondo Beach, CA (US)

Correspondence Address: JAMES M. STOVER;TERADATA CORPORATION, 2835 MIAMI VILLAGE DRIVE, MIAMISBURG, OH, 45342, US

(21) Appl. No.: 11/951,384

(22) Filed: Dec. 6, 2007

Related U.S. Application Data
(60) Provisional application No. 60/878,037, filed on Dec. 29, 2006.

(51) Int. Cl. G06F 17/30

(52) U.S. Cl. 707/4; 707/E17.017

(57) ABSTRACT

In general, the invention features a computer-implemented method for improving the efficiency of execution of a database query including a WHERE clause. The method includes analyzing the satisfiability of the conditions associated with the WHERE clause before executing the query. Furthermore, the method includes modifying the conditions to meet transitive closure, if necessary, before executing the query.

### CROSS REFERENCE TO RELATED APPLICATIONS

This application claims priority under 35 U.S.C. §119(e) to the following co-pending patent application, which is incorporated herein by reference:

Provisional Application Ser. No. 60/878,037, entitled “DETERMINING SATISFIABILITY AND TRANSITIVE CLOSURE OF A WHERE CLAUSE,” filed on Dec. 29, 2006 by Ahmed Ghazal.

### BACKGROUND

Database management systems allow data to be categorized and accessed in a logical manner. Access to data is generally performed via a series of commands. The commands are typically codified as a ‘language’. One common database language is ‘SQL’. The commands generally take the form of a request for a particular type of data from a particular section of the database. The type of data sought by a user can be requested through an SQL query via the inclusion of a condition or constraint. For example, a user may only require sales data from the last 30 days of sales. This may be codified by including a ‘WHERE’ clause in the SQL query.

Conditions can be contradictory or “satisfiable”. That is, in some cases, a constraint may require the database to return information that is logically not available. Checking if a set of conditions are satisfiable can be useful in database management systems. If the query optimizer of the database has the ability to check if a set of conditions is un-satisfiable, then such queries can be answered immediately without accessing some or all of the data tables in a database.

Moreover, the computation of a transitive closure is a useful tool in many database management systems. The transitive closure(TC), of a set of constraints S1, which can be denoted mathematically by the expression TC(S1), is the set of all possible derivable constraints from S1. For example if S1 is (a1=a2 and a1=2) then TC(S1) will be (a2=2). In other words, by determining the transitive closure of a statement, a potentially more efficient statement can be created, which continues to satisfy the requirement set by the original statement (i.e. return the correct data set requested by the user). In turn, a more efficient query statement can result in more efficient execution of the SQL query.

### SUMMARY

In general, in one aspect, the invention features a computer-implemented method for improving the efficiency of execution of a database query including a WHERE and an ON clause. The method includes analyzing the transitive closure of the conditions. Furthermore, the method includes modifying the conditions to meet transitive closure, if necessary, before executing the query.

Implementations of the invention may include one or more of the following The step of analyzing the conditions of the WHERE clause may include determining the conjunctive conditions of the WHERE clause that reference an outer table. The step of modifying the conditions to meet transitive closure may include setting a value equal to the conjunction of the conjunctive conditions and the condition of the ON clause. The step of analyzing the satisfiability of the conditions in the SQL query may be carried out to determine whether a contradiction exists. If a contradiction is found, ‘1=0’ may be appended to the ON clause to modify the conditions to meet transitive closure. Having 1=0 in the ON Clause is useful since, in many cases, the outer join and the inner table can be eliminated, thereby producing a more efficient SQL query. If no contradiction is found, the condition that satisfies transitive closure is appended to the ON clause.

In general, in another aspect, the invention features a computer program, stored on a tangible storage medium, for use in improving the efficiency of execution of a database query including conditions. The program includes executable instructions that cause a computer to analyze the transitive closure of the conditions of a WHERE and an ON clause. Furthermore, the conditions are modified to meet transitive closure, if necessary, before executing the query.

Other features and advantages will become apparent from the description and claims that follow.

### BRIEF DESCRIPTION OF THE DRAWINGS

FIG. 1 is a block diagram of a node of a database system.

FIG. 2 is a block diagram of a parsing engine.

FIG. 3 is a flow chart of a parser.

FIG. 4 is a flow chart of a method utilized to test the satisfiability and transitive closure of an ON and WHERE clause.

### DETAILED DESCRIPTION

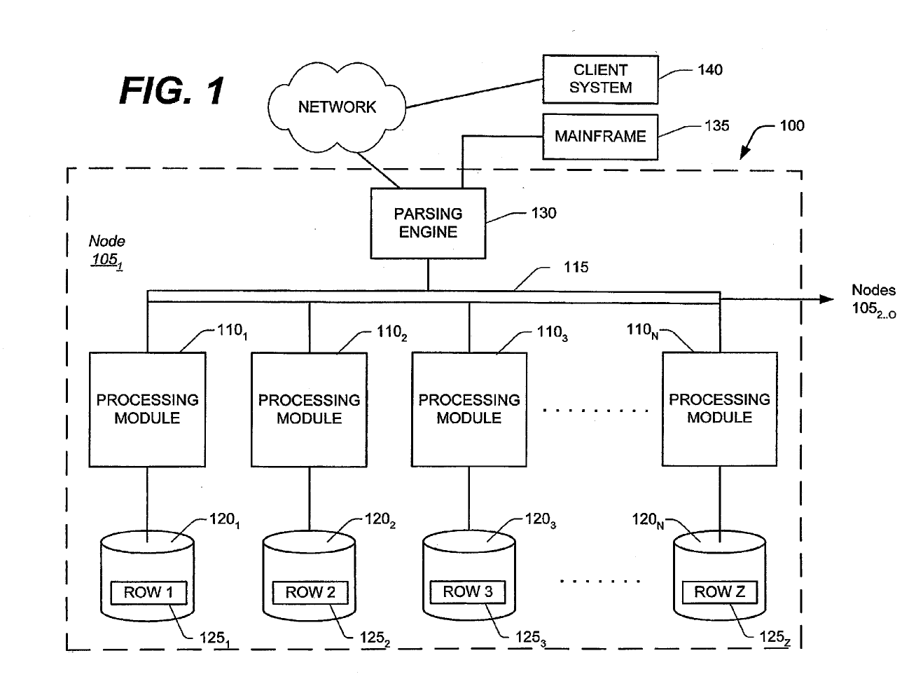

The management technique disclosed herein has particular application to large databases that might contain many millions or billions of records managed by a database system (“DBS”) 100, such as a Teradata Active Data Warehousing System available from NCR Corporation. FIG. 1 shows a sample architecture for one node 1051 of the DBS 100. The DBS node 1051 includes one or more processing modules 110_{1 . . . N}, connected by a network 115 that manage the storage and retrieval of data in data storage facilities 120_{1 . . . N}. Each of the processing modules 110_{1 . . . N} may be one or more physical processors or each may be a virtual processor, with one or more virtual processors running on one or more physical processors.

For the case in which one or more virtual processors are running on a single physical processor, the single physical processor swaps between the set of N virtual processors. Each virtual processor is generally termed an Access Module Processor (AMP) in the Teradata Active Data Warehousing System.

For the case in which N virtual processors are running on an M processor node, the node's operating system schedules the N virtual processors to run on its set of M physical processors. If there are 4 virtual processors and 4 physical processors, then typically each virtual processor would run on its own physical processor. If there are 8 virtual processors and 4 physical processors, the operating system would schedule the 8 virtual processors against the 4 physical processors, in which case swapping of the virtual processors would occur.

Each of the processing modules 110_{1 . . . N} manages a portion of a database that is stored in a corresponding one of the data storage facilities 120_{1 . . . N}. Each of the data storage facilities 120_{1 . . . N} includes one or more disk drives. The DBS may include multiple nodes 105_{2 . . . N} in addition to the illustrated node 105₁, connected by extending the network 115.

The system stores data in one or more tables in the data storage facilities 120_{1 . . . N}. The rows 125_{1 . . . Z} of the tables are stored across multiple data storage facilities 120_{1 . . . N} to ensure that the system workload is distributed evenly across the processing modules 110_{1 . . . N}. A parsing engine 130 organizes the storage of data and the distribution of table rows 125_{1 . . . Z} among the processing modules 110_{1 . . . N}. The parsing engine 130 also coordinates the retrieval of data from the data storage facilities 120_{1 . . . N} in response to queries received from a user at a mainframe 135 or a client computer 140. The DBS 100 usually receives queries in a standard format, such as SQL.

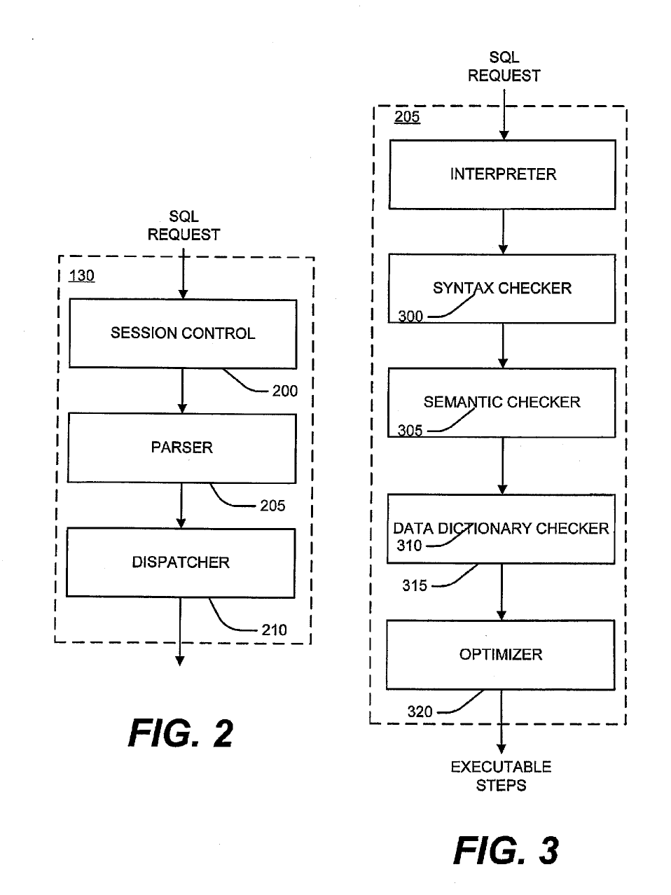

In one example system, the parsing engine 130 is made up of three components: a session control 200, a parser 205, and a dispatcher 210, as shown in FIG. 2. The session control 200 provides the logon and logoff function. It accepts a request for authorization to access the database, verifies it, and then either allows or disallows the access.

Once the session control 200 allows a session to begin, a user may submit a SQL request that is routed to the parser 205. As illustrated in FIG. 3, the parser 205 interprets the SQL request (block 300), checks it for proper SQL syntax (block 305), evaluates it semantically (lock 310), and consults a data dictionary to ensure that all of the objects specified in the SQL request actually exist and that the user has the authority to perform the request (block 315). Finally, the parser 205 runs an optimizer (block 320) that develops the least expensive plan to perform the request.

In some cases it is desirable for the optimizer to derive transitive closure across a specific ON and WHERE clause, in order to produce a more efficient query, which in turns saves processing time. For example, the query “select * from t1 left join t2 on a1=a2 where a1=2” can be re-written as “select * from t1 left join t2 on a1=a2 and a2=2 where a1=2”. The re-written query has an extra condition “a2=2” appended to the ON clause. The appended condition is derived by determining the transitive closure of “a1=a2 and a1=2”.

The optimizer includes a procedure (or module or subroutine) known as ‘Sat-TC’. Sat-TC is utilized to determine whether the SQL expression submitted to the optimizer is satisfiable and also redefines the SQL expression to ensure that it achieves transitive closure. The embodiment described herein presents a method for ensuring satisfiability and transitive closure on the combination of an ON clause and a WHERE clause, for the ON clause of an outer join.

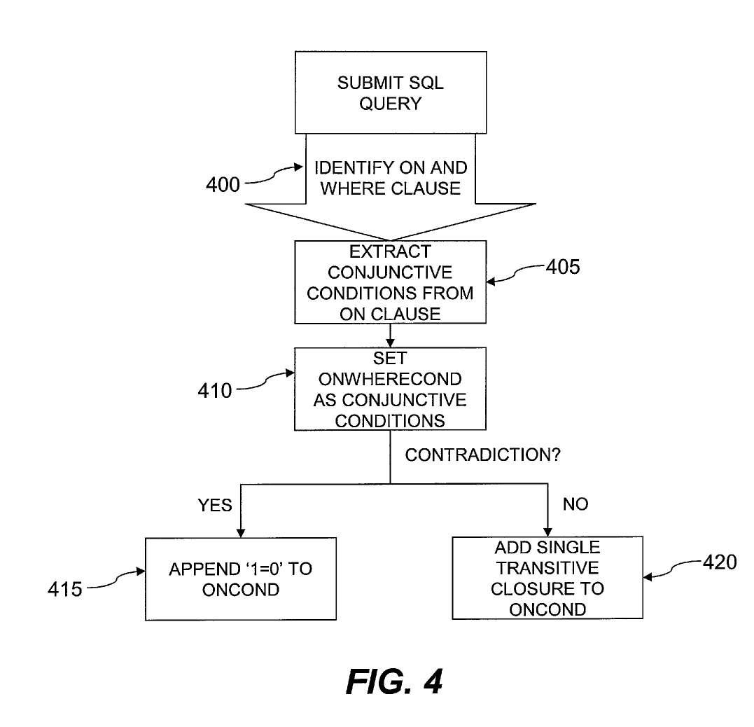

The manner in which satisfiability and transitive closure are determined is given by the pseudo-code below, which is explained with reference to the flow diagram of FIG. 4:

```
/* Procedure CombineONWhere receives an outer join condition ‘ONCond’ and its main block WHERE
clause ‘WHEREcond’. It also receives the outer and inner tables of the outer joinn (‘OuterTable’ and
InnerTable’). */
Procedure CombineONWhere(ONCond, WhereCond, OuterTable, InnerTable)
BEGIN
  1. Pick up conjunctive conditions from ONCond that reference the OuterTable. Call these conditions
    ONAddOn (block 400);
  2. Set ONWhereCond as the conjunction of ONCond and ONAddOn (block 405);
  3. Apply SAT-TC on ONWhereCond (block 410);
  4. If a contradiction is found then append “1=0” to the ONCond (block 415); and
  5. If no contradiction is found, append transitive closure to ONCond (block 420).
END
```

A simplified example of the application of the algorithm is given below, to better illustrate the method steps. In the example, it is assumed that a user submits a query which seeks to access two tables, ‘t1’ and ‘t2’, which each contain at least two columns of integer values, a1 and b1 (for table t1), and a2 and b2 (for table t2). The user submits the following SQL query:
SELECT * from t1 left Join t2 ON a1=a2 WHERE a1=1;

From the SQL presented above, the ‘ON’ condition is a1=a2 and the ‘WHERE’ condition is a1=1.

If the procedure CombineONWHERE is called, then the following method steps are followed:
1. The conjunctive conditions from ONCondition that reference the outer table are extracted. This conjunctive condition is held by the value ONAddOn:
   ONAddOn is (a1=1)
2. The value OnWhereCond is set as the conjunction of OnCond and ONAddOn:
   OnWhereCond is (a1=1 AND a1=a2)
3. SAT-TC is applied to the value OnWhereCond to achieve transitive closure, as per the standard method for achieving transitive closure:
   OnWhereCond becomes (a1=1 and a1=a2 and a2=1)
4. If a contradiction is found, then append ‘1=0’ to the OnCond:
   (no contradiction in this example)
5. If no contradiction is found, append the transitive closure to ONCond:
   OnCond becomes (a1=a2 and a2=1)

Therefore, the query becomes:
SELECT * from t1 left join t2 ON (a1=a2 and a2=1) WHERE a1=1.

This query has now achieved transitive closure and in doing so provides a Primary Index access path to table t2, thereby only requiring a row hash access on table t2 to extract the appropriate data. This is a more efficient method of performing the SQL query than the query provided by the user.

An informal proof of the correctness of the method outlined above is now provided for completeness:

Assume Cond1 is derived by CombineONWhere. Let us consider the difference between “OnCond” and “OnCond and Cond1”, which is termed NewOnCond. NewOnCond may produce more non-matching rows than OnCond.

This can be tested by working through an example. CombineONWhere re-writes the query “SELECT a1, a2 from t1 left join t2 ON a1=a2 WHERE a1=1” to “SELECT a1, a2 from t1 left join t2 ON a1=a2 and a2=1 WHERE a1=1”. Assume that t1 has two rows (a1=1 and a1=2) and t2 has two rows (a2=1 and a2=2). The outer join in the re-written query based on this data produces one matching row (a1=1, a2=1) and one non-matching row (a1=2, a2=?). The original query outer join produces two matching rows (a1=1, a2=1) and (a1=2,a2=2). The WHERE clause in both forms produces the same result which is a single row (a1=1, a2=1). In contrast, the re-written query converts what was a matching row (a1=2, a2=2) into a non-matching row (a1=2, a2=?).

However, the WHERE clause filters out these rows in both cases. The non-matching rows produced by the extra condition in the ON clause will always be filtered by the WHERE clause. This logical sequence of the outer join followed by the WHERE clause is used for illustration of the proof. In reality, the optimizer applies outer table conditions in the WHERE clause before the outer join. In effect, both the re-written and original queries produce one matching row after the outer join which is (a1=1, a2=1).

It is also noted that CombineONWhere selectively derives transitive closure for the ON clause of the outer join. It does not consider conditions from the WHERE clause that are applied on the InnerTable.

This is due to the fact that if the condition on an InnerTable is not of a Null Filtering Condition (NFC) type, then considering part of the cross ON and WHERE clauses could lead to an incorrect result.

A condition is called NFC with respect to a field X if substituting a null value for X makes the condition always false. For example, A1>2 is NFC for A1 since NULL>2 is always false. A1<A2 is NFC for both A1 and A2 since all of “null<non-null”, “null<null” and “non-null<null” are false.

Some examples of conditions that are not NFC's include:

“X is null” is not NFC for all X since “null is null” is TRUE;

Zeroifnull(X)>Y is not NFC since zeroifnull(null)>Y which is 0>Y is TRUE for negative values of Y. This same condition is NFC for Y; and

Coalesce(X,2)>1 is also not NFC. This condition is always true if X is null.

To illustrate this point, consider the query “select a1, a2 from t1 left join t2 on a1=a2 where a2 is null”. The condition “a2 is null” is applied on the inner table t2 and it is not NFC since it is TRUE for null values of b2. Combining this condition with the ON clause derives “a1 is null”. Assume t1 has one row with a1 equals to 1. Also, assume that t2 has one row with a2 set to 1. If either “a2 is null” or “a1 is null” is applied in the ON clause, the query produce one row. The original query returns no rows. The reason is that the additional conditions turn some matching rows into non-matching rows (a1=1 and a2=1 becomes a1=1 and a2=?) and the WHERE clause picks up only the non-matching rows.

If the condition on InnerTable is NFC, then the outer join will been converted to an inner join. As the ON clause and the WHERE clause will be combined after the outer to inner join conversion, then there is no need to consider this case. Therefore, the embodiment described herein applies SAT-TC (i.e. transitive closure) for the ON clause, but does not need to consider conditions from the WHERE clause that are applied on the inner table.

The text above described one or more specific embodiments of a broader invention. The invention also is carried out in a variety of alternative embodiments and thus is not limited to those described here. For example, while the invention has been described here in terms of a DBS that uses a massively parallel processing (MPP) architecture, other types of database systems, including those that use a symmetric multiprocessing (SMP) architecture, are also useful in carrying out the invention. Many other embodiments are also within the scope of the following claims.

We claim:

1. A computer-implemented method for improving the efficiency of execution of a s database SQL query where the query includes a WHERE and an ON clause, the method including:
analyzing conditions of the WHERE clause and the ON clause; and
modifying the conditions to meet transitive closure, if necessary, before executing the query.

2. A computer-implemented method in accordance with claim 1, where the step of analyzing the conditions of the WHERE clause includes: determining the conjunctive conditions of the WHERE clause that reference an outer table.

3. A computer-implemented method in accordance with claim 2, where the step of modifying the conditions to meet transitive closure includes setting a value equal to the conjunction of the conjunctive conditions and the condition of the ON clause.

4. A computer-implemented method in accordance with claim 1, further including the step of analyzing the satisfiability of the conditions in the SQL query to determine whether a contradiction exists.

5. A computer-implemented method in accordance with claim 3, further including the step of, if a contradiction is found, appending ‘1=0’ to the ON clause to modify the conditions to meet transitive closure.

6. A computer-implemented method in accordance with claim 3, further including the step of if no contradiction is found, appending the condition that satisfies transitive closure to the ON clause.

7. A computer program, stored on a tangible storage medium, for use in improving the efficiency of execution of a SQL database query including a WHERE and an ON clause, the program including executable instructions that cause a computer to:
analyze the transitive closure of the WHERE clause; and
modify the conditions to meet transitive closure, if necessary, before executing the query.

8. A computer program in accordance with claim 7, where the instruction to analyze the conditions of the WHERE clause includes: determining the conjunctive conditions of the WHERE clause that reference an outer table.

9. A computer program in accordance with claim 8, where the instruction to modify the conditions to meet transitive closure includes: setting a value equal to the conjunction of the conjunctive conditions and the condition of the ON clause.

10. A computer program in accordance with claim 8, where the instruction to analyze the satisfiability of the conditions in the SQL query to determine whether a contradiction exists.

11. A computer program in accordance with claim 10, where the instruction to analyze the satifiability of the conditions includes: if a contradiction is found, appending ‘1=0’ to the ON clause to modify the conditions to meet transitive closure.

12. A computer program in accordance with claim 10, where the instruction to analyze the satifiability of the conditions includes: if no contradiction is found, appending the condition that satisfies transitive closure to the ON clause.
